(19) United States
(12) Patent Application Publication
(10) Pub. No.: US 2015/0049676 A1
(43) Pub. Date: Feb. 19, 2015

(54) Configuration Uncertainty

(71) Applicants: Esa Tapani Tiirola, Kempele (FI); Kari Juhani Hooli, Oulu (FI); Peng Chen, Beijing (CN)

(72) Inventors: Esa Tapani Tiirola, Kempele (FI); Kari Juhani Hooli, Oulu (FI); Peng Chen, Beijing (CN)

(73) Assignee: Nokia Siemens Networks Oy, Espoo (FI)

(21) Appl. No.: 13/883,604

(22) PCT Filed: Nov. 5, 2010
(86) PCT No.: PCT/CN2010/078442

§ 371 Date: Oct. 6, 2014

(51) Int. Cl. H04L 5/00

(52) U.S. Cl. CPC H04L 5/0085; H04L 5/0053
USPC 370/329

(57) ABSTRACT

For an initial period after informing a user equipment of a change in the number of carriers configured for transmissions from a transmitting device to the user equipment from a first carrier set to a second carrier set, wherein at least one of the first and second carrier sets contains a plurality of carriers: refraining from scheduling data transmissions to said user equipment on one or more carriers other than those common to both said first and second carrier sets; and decoding feedback information received from said user equipment using a number of code basis sequences according to the number of carriers common to both said first and second carrier sets.

The present invention relates to making transmissions in a communication system where there can be uncertainty at a receiving device about the configuration of a transmitting device

A communication device can be understood as a device provided with appropriate communication and control capabilities for enabling use thereof for communication with others parties. The communication may comprise, for example, communication of voice, electronic mail (email), text messages, data, multimedia and so on. A communication device typically enables a user of the device to receive and transmit communication via a communication system and can thus be used for accessing various service applications.

A communication system is a facility which facilitates the communication between two or more entities such as the communication devices, network entities and other nodes. A communication system may be provided by one or more interconnect networks. One or more gateway nodes may be provided for interconnecting various networks of the system. For example, a gateway node is typically provided between an access network and other communication networks, for example a core network and/or a data network.

An appropriate access system allows the communication device to access to the wider communication system. An access to the wider communications system may be provided by means of a fixed line or wireless communication interface, or a combination of these. Communication systems providing wireless access typically enable at least some mobility for the users thereof. Examples of these include wireless communications systems where the access is provided by means of an arrangement of cellular access networks. Other examples of wireless access technologies include different wireless local area networks (WLANs) and satellite based communication systems.

A wireless access system typically operates in accordance with a wireless standard and/or with a set of specifications which set out what the various elements of the system are permitted to do and how that should be achieved. For example, the standard or specification may define if the user, or more precisely user equipment, is provided with a circuit switched bearer or a packet switched bearer, or both. Communication protocols and/or parameters which should be used for the connection are also typically defined. For example, the manner in which communication should be implemented between the user equipment and the elements of the networks and their functions and responsibilities are typically defined by a predefined communication protocol. Such protocols and or parameters further define the frequency spectrum to be used by which part of the communications system, the transmission power to be used etc.

In the cellular systems a network entity in the form of a base station provides a node for communication with mobile devices in one or more cells or sectors. It is noted that in certain systems a base station is called ‘Node B (NB)’ or “eNode B (eNB)”. Typically the operation of a base station apparatus and other apparatus of an access system required for the communication is controlled by a centralised control entity (which centralised control entity is typically interconnected with other centralised control entities of the particular communication network), or every base station (e.g. eNodeB) contains its own local control entity. Examples of cellular access systems include, in order of their evolution, GSM (Global System for Mobile) EDGE (Enhanced Data for GSM Evolution) Radio Access Networks (GERAN), Universal Terrestrial Radio Access Networks (UTRAN) and evolved UTRAN (E-UTRAN).

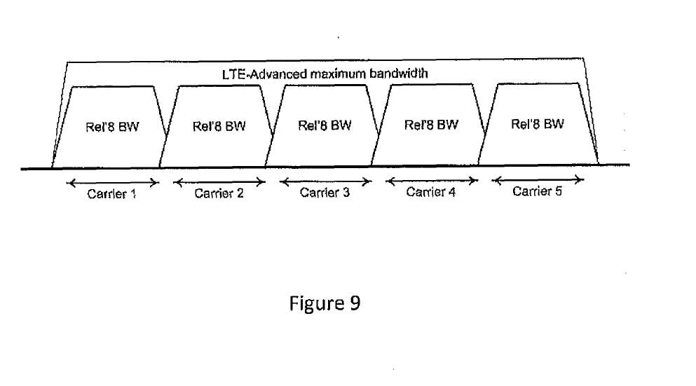

In the Long Term Evolution (LTE) System Release 8, a device makes an uplink transmission according to a single carrier frequency division multiple access technique. Each uplink transmission is made using a group of orthogonal sub-carriers. Sub-carriers are grouped into units called resource blocks, and a device can make an uplink transmission using groups of resource blocks ranging up to a predetermined maximum number of resource blocks within a pre-determined frequency block called a component carrier (CC). The bandwidth available for uplink transmissions generally comprises a plurality of CCs; and a device makes an uplink transmission on a selected one of the CCs. A further development of LTE Release 8 (which development is known as LTE-Advanced) provides for carrier aggregation, where two or more CCs are aggregated in order to support transmission bandwidths wider than that defined by a single CC. In summary, devices operating under LTE Release 8 are served by a single CC, whereas devices operating under LTE-Advanced can receive or transmit simultaneously on a plurality of CCs. This division of the spectrum into CCs and the aggregation of such CCs is illustrated in FIG. 9.

One technique of providing feedback information to an access node about transmissions received at the user equipment (UE) from the access node involves channel coding of this feedback information before transmission. It should be noted that channel coding can be realized by means of pre-determined coding scheme (e.g., Reed-Muller) or alternatively by means of channel selection. According to one proposal, different numbers of code basis sequences (i.e. different codebook sizes) are used by the UE for encoding depending on the number of bits comprising the feedback information for one uplink (UL) subframe, which number of bits depends on the number of CCs configured, or in other words, enabled for transmission. It should be noted that the transmission to which the feedback information relates can use all configured CCs or any subset of the configured CCs. According to another proposal, different numbers of PUCCH Format 1b resources are used by the UE for transmission depending on the number of bits comprising the feedback information of one uplink (UL) subframe, which number of bits depends on the number of CCs for the transmission to which the feedback information relates.

There has been identified the challenge of correctly processing transmissions at a receiving device where there is some uncertainty at the receiving device about the configuration of the transmitting device.

More particularly, there has been identified the challenge of correctly processing coded feedback information at an access node in a carrier aggregation system at a time of change in the number of CCs configured for transmissions from the access node to the UE.

It is an aim to meet one or more of these challenges.

There is provided a method comprising: for an initial period after informing a receiving device of a change in the number of carriers configured for transmissions from a transmitting device to the receiving device from a first carrier set to a second carrier set, wherein at least one of the first and second carrier sets contains a plurality of carriers: refraining from scheduling data transmissions to said receiving device on one or more carriers other than those common to both said first and second carrier sets; and decoding feedback information received from said receiving device using a number of code basis sequences according to the number of carriers common to both said first and second carrier sets.

In one embodiment, the method comprises: for said initial period, receiving from said receiving device feedback information encoded using a number of code basis sequences according to the number of carriers in the second carrier set; and decoding said feedback information received from said receiving device using a number of code basis sequences according to the number of carriers common to both said first and second carrier sets.

In one embodiment, said feedback information is transmitted by discrete fourier transform spread orthogonal frequency divisional multiplexing.

In one embodiment, said feedback information is transmitted via an uplink shared channel using scheduling information received at said receiving device on a downlink control channel.

In one embodiment, the method comprises receiving said feedback information on the basis that the number of symbols of said shared channel used for said feedback information accords with the number of carriers common to said first and second carrier sets.

There is also provided a method comprising: transmitting on a control channel from a transmitting device scheduling information for transmissions to or from a receiving device; and including with said scheduling information an indication of a setting for a transmission parameter for feedback information that would otherwise be determined at the receiving device on the basis of a current configuration of the receiving device.

In one embodiment, said indication is an indication of the number of coding basis sequences to be used for coding feedback information about one or more transmissions received at the receiving device from the access node.

In one embodiment, said number of coding basis sequences is the number of coding basis sequences to be used for the transmission of feedback information from the receiving device irrespective of the number of carriers for which said receiving device is configured.

There is also provided a method comprising: receiving at a receiving device on a control channel scheduling information for transmissions to or from said receiving device; and checking said scheduling information for an indication of a setting for a transmission parameter for feedback information that would otherwise be determined at the receiving device on the basis of a current configuration of the receiving device.

In one embodiment, said indication comprises an indication of the number of coding basis sequences to be used for coding feedback information about one or more transmissions received at the receiving device; and the method comprises coding feedback information for transmission from said receiving device according to said indication.

In one embodiment, the method comprises coding feedback information for transmission from said receiving device according to said indication irrespective of the number of carriers for which said receiving device is configured.

There is also provided an apparatus comprising: a processor and memory including computer program code, wherein the memory and computer program code are configured to, with the processor, cause the apparatus to: for an initial period after informing a receiving device of a change in the number of carriers configured for transmissions from a transmitting device to the receiving device from a first carrier set to a second carrier set, wherein at least one of the first and second carrier sets contains a plurality of carriers: refrain from scheduling data transmissions to said receiving device on one or more carriers other than those common to both said first and second carrier sets; and decode feedback information received from said receiving device using a number of code basis sequences according to the number of carriers common to both said first and second carrier sets.

In one embodiment, the memory and computer program code are configured to, with the processor, cause the apparatus to: for said initial period, receive from said receiving device feedback information encoded using a number of code basis sequences according to the number of carriers in the second carrier set; and decode said feedback information received from said receiving device using a number of code basis sequences according to the number of carriers common to both said first and second carrier sets.

In one embodiment, said feedback information is transmitted by discrete fourier transform spread orthogonal frequency divisional multiplexing.

In one embodiment, said feedback information is transmitted via an uplink shared channel using scheduling information received at said receiving device on a downlink control channel.

In one embodiment, the memory and computer program code are configured to, with the processor, cause the apparatus to: receive said feedback information on the basis that the number of symbols of said shared channel used for said feedback information accords with the number of carriers common to said first and second carrier sets.

There is also provided an access node, base station or eNodeB comprising apparatus as described above.

There is also provided an apparatus comprising: a processor and memory including computer program code, wherein the memory and computer program code are configured to, with the processor, cause the apparatus to: transmit on a control channel from a transmitting device scheduling information for transmissions to or from a receiving device; and include with said scheduling information an indication of a setting for a transmission parameter for feedback information that would otherwise be determined at the receiving device on the basis of a current configuration of the receiving device

In one embodiment, said indication is an indication of the number of coding basis sequences to be used for coding feedback information about one or more transmissions received at the receiving device.

In one embodiment, said number of coding basis sequences is the number of coding basis sequences to be used for the transmission of feedback information from the receiving device irrespective of the number of carriers for which said receiving device is configured.

There is also provided an apparatus comprising: a processor and memory including computer program code, wherein the memory and computer program code are configured to, with the processor, cause the apparatus to: receive at a receiving device on a control channel scheduling information for transmissions to or from said receiving device; and check said scheduling information for an indication of a setting for a transmission parameter for feedback information that would otherwise be determined at the receiving device on the basis of a current configuration of the receiving device.

In one embodiment, said indication comprises an indication of the number of coding basis sequences to be used for coding feedback information about one or more transmissions received at the receiving device; and the memory and computer program code are configured to, with the processor, cause the apparatus to code feedback information for transmission from said receiving device according to said indication.

In one embodiment, the memory and computer program code are configured to, with the processor, cause the apparatus to code feedback information for transmission from said receiving device according to said indication irrespective of the number of carriers for which said receiving device is configured.

There is also provided a user equipment or relay node comprising apparatus as described above.

There is also provided a computer program product comprising program code means which when loaded into a computer controls the computer to: for an initial period after informing a receiving device of a change in the number of carriers configured for transmissions from a transmitting device to the receiving device from a first carrier set to a second carrier set, wherein at least one of the first and second carrier sets contains a plurality of carriers: refrain from scheduling data transmissions to said receiving device on one or more carriers other than those common to both said first and second carrier sets; and decode feedback information received from said receiving device using a number of code basis sequences according to the number of carriers common to both said first and second carrier sets.

There is also provided a computer program product comprising program code means which when loaded into a computer controls the computer to: transmit on a control channel from a transmitting device scheduling information for transmissions to or from a receiving device; and include with said scheduling information an indication of a setting for a transmission parameter for feedback information that would otherwise be determined at the receiving device on the basis of a current configuration of the receiving device.

There is provided a computer program product comprising program code means which when loaded into a computer controls the computer to: receive at a receiving device on a control channel scheduling information for transmissions to or from said receiving device; and check said scheduling information for an indication of a setting for a transmission parameter for feedback information that would otherwise be determined at the receiving device on the basis of a current configuration of the receiving device.

Hereunder is provided, by way of example only, a detailed description of techniques related to the encoding and decoding of feedback information, with reference to the accompany drawings, in which:

FIG. 1 illustrates an example of a communication system including a radio access network;

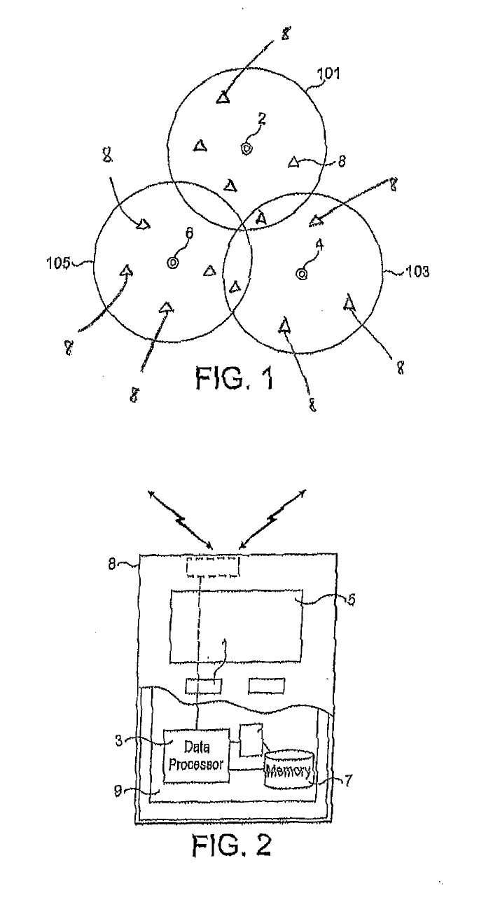

FIG. 2 illustrates some components of one example of user equipment as shown in FIG. 1;

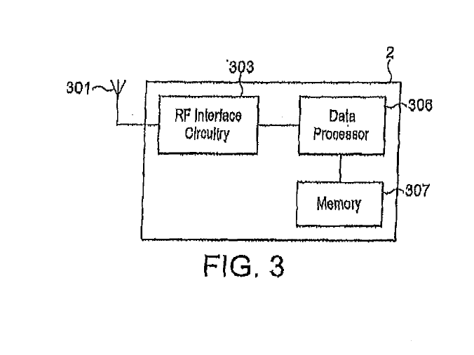

FIG. 3 illustrates some components of an example of an apparatus suitable for the access nodes shown in FIG. 1;

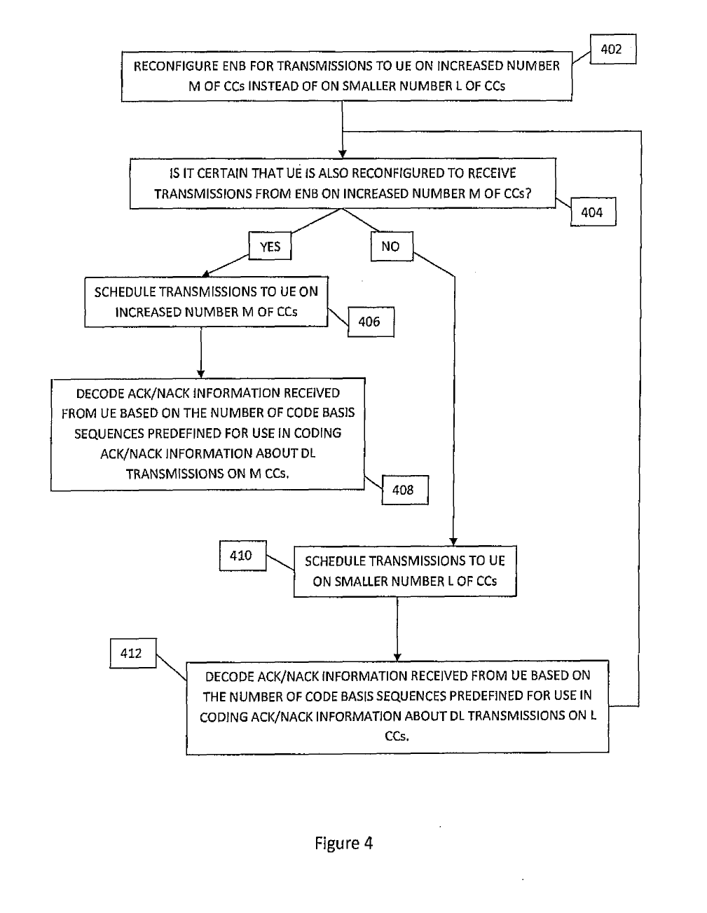

FIG. 4 illustrates one example of operations carried out at an eNB of FIG. 1.

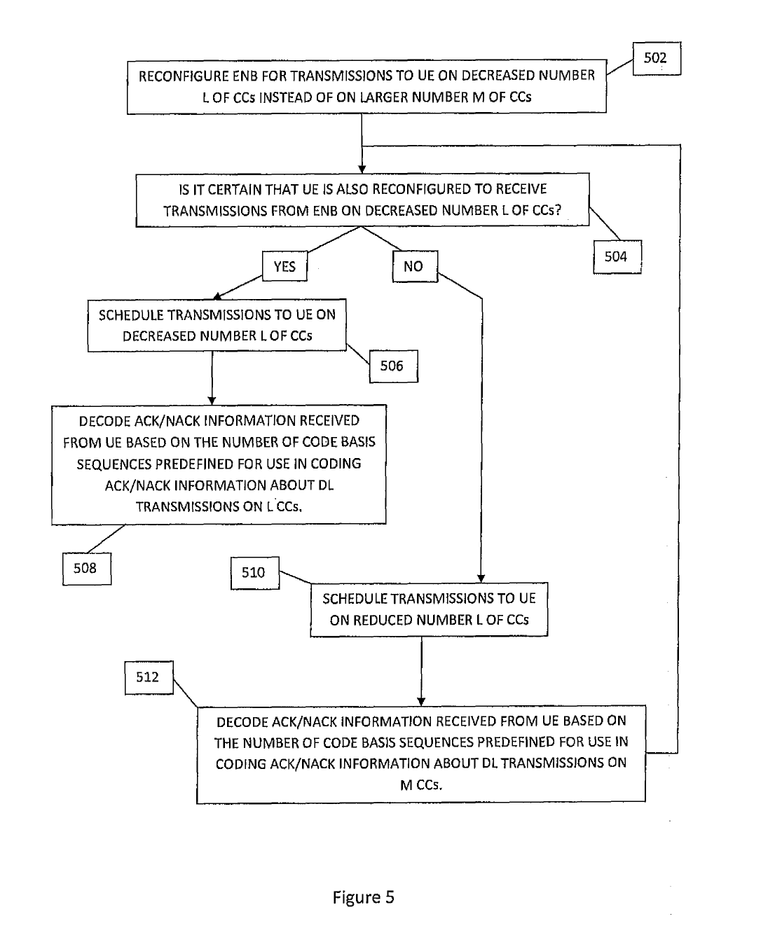

FIG. 5 illustrates another example of operations carried out at an eNB of FIG. 1;

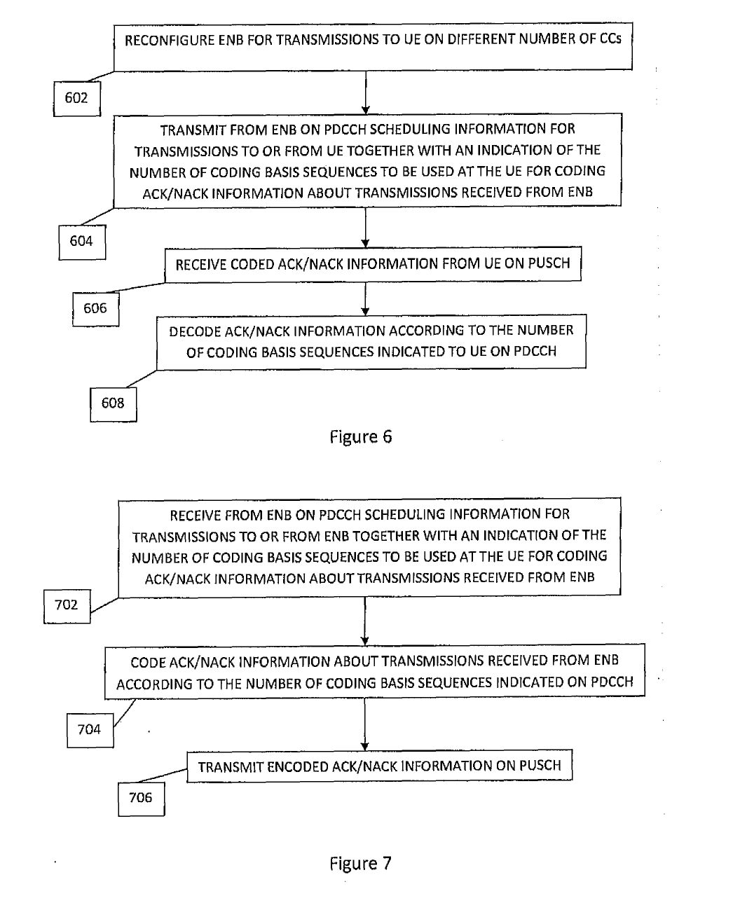

FIG. 6 illustrates another example of operations carried out at an eNB of FIG. 1;

FIG. 7 illustrates one example of operations carried out at a UE in FIG. 1.

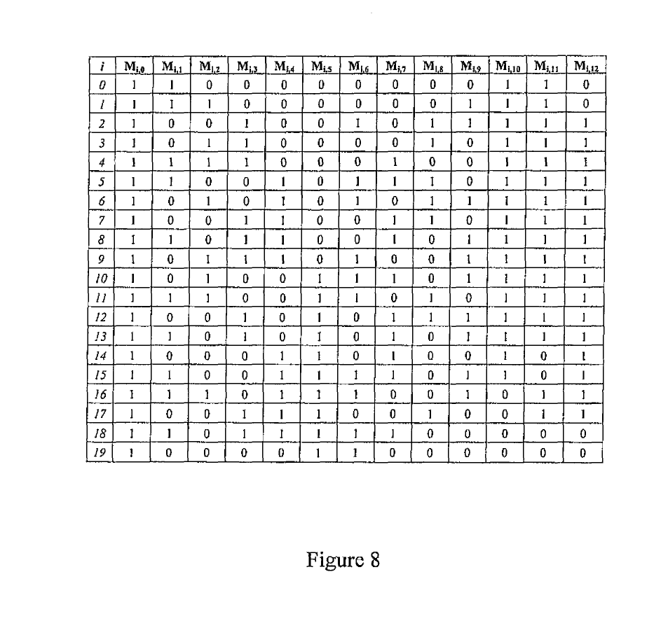

FIG. 8 illustrates one example of code basis sequences for use in the encoding and decoding of feedback information; and

FIG. 9 illustrates the division of the frequency spectrum into component carriers and the aggregation of such carriers in LTE-Advanced.

The following description relates to the example of a communication system including a radio access network designed to operate in accordance with Long Term Evolution (LTE) Release 10 or beyond.

FIG. 1 illustrates an example of a cellular E-UTRAN including a network of base stations 2, 4, 6 (eNBs).

For simplicity, only three cells are shown in FIG. 1, but a large cellular radio access network can have tens of thousands of cells.

FIG. 2 illustrates some components of one example of user equipment as shown in FIG. 1. The user equipment (UE) 8 may be used for various tasks such as making and receiving phone calls, for receiving and sending data from and to a data network and for experiencing, for example, multimedia or other content.

The UE 8 may be any device capable of at least sending or receiving radio signals. Non-limiting examples include a mobile station (MS), a portable computer provided with a wireless interface card or other wireless interface facility, personal data assistant (PDA) provided with wireless communication capabilities, a relay node, or any combinations of these or the like. The UE 8 may communicate via an appropriate radio interface arrangement of the UE 8. The interface arrangement may be provided for example by means of a radio part and associated antenna arrangement. The antenna arrangement may be arranged internally or externally to the UE 8.

The UE 8 may be provided with at least one data processing entity 3 and at least one memory or data storage entity 7 for use in tasks it is designed to perform. The data processor 3 and memory 7 may be provided on an appropriate circuit board 9 and/or in chipsets.

The user may control the operation of the UE 8 by means of a suitable user interface such as key pad 1, voice commands, touch sensitive screen or pad, combinations thereof or the like. A display 5, a speaker and a microphone may also be provided. Furthermore, the UE 8 may comprise appropriate connectors (either wired or wireless) to other devices and/or for connecting external accessories, for example hands-free equipment, thereto.

FIG. 3 illustrates some components of an example of an apparatus suitable for the access nodes 2, 4, 6 shown in FIG. 1. The apparatus 2 may comprise a radio frequency antenna 301 configured to receive and transmit radio frequency signals, radio frequency interface circuitry 303 configured to interface the radio frequency signals received and transmitted by the antenna 301. The radio frequency interface circuitry may also be known as a transceiver. The apparatus 2 may also comprise a data processor 306 configured to process signals from the radio frequency interface circuitry 303, control the radio frequency interface circuitry 303 to generate suitable RF signals. The access node may further comprise a memory 307 for storing data, parameters and instructions for use by the data processor 306.

It will be understood that both the UE 8 and access nodes shown in FIGS. 2 and 3 respectively and described above may comprise further elements which are not directly involved with the embodiments described hereafter.

The spectrum available for transmissions between the user equipments 8 and the eNBs 2, 4, 6 is divided into CCs each of equal bandwidth (e.g. 20 MHz bandwidth);

and bandwidth extension beyond the bandwidth of one single CC (e.g. beyond 20 MHz) is accomplished via aggregation of two or more of these CCs. UE 8 can receive/transmit on multiple CCs at the same time for both time division duplex (TDD) or frequency division duplex (FDD) systems.

When eNB 2 determines that more or less multiple downlink (DL) CCs are required or desirable for transmissions to UE 8, eNB 2 uses Radio Resource Control (RRC)-level signalling to instruct the UE 8 to reconfigure itself for receiving DL transmissions on the new number of CCs identified in the RRC-level signalling.

In the event that DL transmissions were being made on one or more CCs (e.g. carriers 1 and 2 of FIG. 9), but are now to be made on a greater number of carriers including the CCs used under the old configuration (e.g. carriers 1, 2, 3 and 4 of FIG. 9), the operation of eNB is illustrated in FIG. 4.

In the opposite kind of situation in which DL transmissions were being made on a relatively large number CCs (e.g. carriers 1, 2, 3 and 4 of FIG. 9), but are now to be made on only a selected number of those CCs (e.g. carriers 1 and 2 of FIG. 9), the operation of eNB is illustrated in FIG. 5.

In either case, after the eNB 2 configures itself for DL transmissions on a new number of CCs (STEPs 402 and 502), the eNB 2 makes a determination as to whether it can be certain that the UE 8 has completed the necessary processing for reconfiguring itself in accordance with the RRC-level signalling transmitted to UE 8 (STEPS 404 and 504). If the result of this determination is positive (such determination can be based, for example, on the expiry of a predefined period of time (guard time) after configuration of the eNB, or on the basis of receipt of ACK from higher layers), then eNB 2 begins scheduling transmissions on the new number of CCs (STEPS 406 and 506); sends Media Access Control (MAC)-level scheduling information for UE 2 on Physical Downlink Control Channel (PDCCH); and decodes acknowledgment/non-acknowledgment (ACK/NACK) information received for those DL transmissions according to the number of code basis sequences (i.e. codebook size) predefined for use in coding ACK/NACK information about DL transmissions on such a number of aggregated CCs (STEPS 408 and 508). When eNB 2 decodes the ACK/NACK information, it assumes that the coded ACK/NACK symbols are inserted on PUSCH as follows. UE 8 punctures, or replaces PUSCH data with ACK/NACK information on predefined PUSCH symbols. The total number of these predefined PUSCH symbols punctured with coded ACK/NACK symbols is predefined based on the size of PUSCH resource allocation, on the number of uncoded PUSCH data bits as well as on the size of ACK/NACK information, or equally, on codebook size. In the following, the predetermination of the total number of coded ACK/NACK symbols is referred to as ACK/NACK resource dimensioning.

On the other hand, if the result of the determination is negative, then the eNB 2 refrains from scheduling transmissions on any CCs other than those common to the old and new sets of CCs (STEPS 410 and 510); but decodes ACK/NACK information received from the UE on the Physical Uplink Shared Channel (PUSCH) for those DL transmissions on the basis of the assumption that UE 8 has configured itself for transmissions on the smaller set of CCs from the new and old configured CC sets, i.e. eNB 2 decodes the ACK/NACK information on the basis of a number of basis code sequences (i.e. codebook size) predefined for such decoding in the case of DL transmissions on such a number of CCs (STEPS 412 and 512) using PUSCH symbols predefined ACK/NACK transmission on such number of CCs. Additionally, eNB decodes user data received from the UE on the PUSCH on the basis of the assumption that UE 8 has configured itself for transmissions on the larger set of CCs from the new and old CC sets, i.e. eNB 2 assumes that the ACK/NACK information has punctured PUSCH data symbols predefined for such a number of CCs.

For the purpose of further explaining the above, we shall now consider the kind of situation to which FIG. 4 relates, i.e. the situation where the eNB 2 reconfigures itself for DL transmissions to the UE on an increased number M of CCs instead of a lesser number L of CCs under the old configuration.

UE 8 generates ACK/NACK bits according to whether or not it requires re-transmission of a DL transmission, and performs encoding of the ACK/NACK bits to produce a set of RM encoded bits according to:

$${b}_{i} = {\sum }_{n = 0}^{A - 1} ( {a}_{n} \cdot {M}_{i , n} ) mod 2$$

where aₙε{0,1} is the nth ACK/NAK bit, and M_{i,n} is the nth one of the set of basis code sequences for Reed-Muller (RM) encoding set out in the table of FIG. 8.

If UE 8 has in fact reconfigured itself for receiving DL transmissions on the new set of M carriers (despite the fact that eNB 2 could not be certain that UE 8 had done so), then the set of encoded ACK/NACK bits is defined by:

$${b}_{i} = ( {\sum }_{n = 0}^{L - 1} ( {a}_{n} \cdot {M}_{i , n} ) + {\sum }_{n = L}^{M - 1} ( 0 \cdot {M}_{i , n} ) ) mod 2 = {\sum }_{n = 0}^{L - 1} ( {a}_{n} \cdot {M}_{i , n} ) mod 2$$

On the other hand, if UE 8 has not been able to reconfigure itself for receiving DL transmissions on the new set of M carriers (in line with the negative determination at eNB 2), then the set of encoded ACK/NACK bits is defined by:

$${b}_{i} = {\sum }_{n = 0}^{L - 1} ( {a}_{n} \cdot {M}_{i , n} ) mod 2$$

Accordingly, the encoded ACK/NACK bits are defined by:

$${b}_{i} = {\sum }_{n = 0}^{L - 1} ( {a}_{n} \cdot {M}_{i , n} ) mod 2 ,$$

irrespective of whether UE 8 has reconfigured itself for receiving DL transmissions on the new set of M carriers; and eNB 2 can be sure of correctly decoding the ACK/NACK information if: (i) the ACK/NAK receiver at eNB 2 assumes that PUSCH ACK/NAK resources are dimensioned according to L; (ii) the PUSCH receiver at eNB 2 assumes that PUSCH ACK/NAK resources are dimensioned according to M; and (iii) ACK/NAK decoding at eNB 2 is based on:

$${b}_{i} = {\sum }_{n = 0}^{L - 1} ( {a}_{n} \cdot {M}_{i , n} ) mod 2.$$

The same is true for the situation in which eNB reconfigures itself for transmissions to UE 8 on a reduced number of CCs.

One alternative technique is illustrated in FIGS. 6 and 7, from the points of view of eNB 2 and UE 8, respectively.

After configuring itself for transmissions to UE on a new number of CCs (STEP 602), and during at least the period in which eNB 2 cannot be certain that UE has also reconfigured itself for receiving transmissions on the new number of CCs, eNB 2 includes (STEP 604) with MAC-level scheduling information transmitted on PDCCH an indication of the number of basis code sequences (i.e. codebook size) that should be used for encoding the ACK/NACK information to be transmitted from UE 8 to eNB 2 on PUSCH. This can be done by setting bit(s) or codepoint in at least one DL or UL resource allocation grant on PDCCH. UE 8 monitors PDCCH for transmissions addressed to it, and detects the scheduling information and the above-mentioned codebook size information (STEP 702). UE 8 encodes the ACK/NACK bits according to the codebook size indicated on PDCCH, regardless of the number of CCs for which it is configured to receive DL transmissions from eNB 2 (STEP 704). UE 8 transmits the encoded ACK/NACK bits on PUSCH via resources for which it has received scheduling information on PDCCH (STEP 706). eNB 2 receives the encoded ACK/NACK bits on PUSCH (STEP 606); and decodes the encoded ACK/NACK bits according to the codebook size indicated to UE 8 via PDCCH, regardless of the number of CCs on which eNB 2 is configured to make transmissions to UE 8.

If UE 8 does detect the scheduling information on PDCCH, then it also has the codebook size information, and there is no concern about any lack of synchronization between the UE 8 and eNB 2 in respect to the codebook size to be used for encoding and decoding the ACK/NCK information. On the other hand, if UE 8 happens not to detect the codebook size information on PDCCH, then it will also not have detected the scheduling information with which the codebook size information was included. Accordingly, there would then be no ACK/NACK information sent from UE 8 to eNB 2, and there is no concern about what codebook size to use at eNB 2.

The kind of technique described above can also be used in other kinds of situations where a transmission parameter depends on the configuration of the UE 8, and there is uncertainty at eNB 2 about the configuration of UE 8, such as for example, in an initial period after instructing a reconfiguration of PUCCH transmissions from 1-antenna port mode to Tx diversity mode.

The above-description of techniques is set in the context of transmitting encoded ACK/NACK information on PUSCH. However the same kind of techniques also have application, for example, to the transmission of encoded ACK/NACK information via the Physical Uplink Control Channel (PUCCH) according to discrete fourier transform spread orthogonal frequency divisional multiplexing (DFT-s-OFDM). PUCCH is used by UE 8 for sending control information such as ACK/NACK information when UE 8 is not allocated any resources for sending user data on PUSCH; and there is no multiplexing of the ACK/NACK information with user data on PUCCH. It is also possible to configure control signalling in such a way that ACK/NACK information is always transmitted on PUCCH regardless of the presence of user data on PUSCH.

The above-described operations may require data processing in the various entities. The data processing may be provided by means of one or more data processors. Similarly various entities described in the above embodiments may be implemented within a single or a plurality of data processing entities and/or data processors. Appropriately adapted computer program code product may be used for implementing the embodiments, when loaded to a computer. The program code product for providing the operation may be stored on and provided by means of a carrier medium such as a carrier disc, card or tape. A possibility is to download the program code product via a data network. Implementation may be provided with appropriate software in a server.

For example the embodiments may be implemented as a chipset, in other words a series of integrated circuits communicating among each other. The chipset may comprise microprocessors arranged to run code, application specific integrated circuits (ASICs), or programmable digital signal processors for performing the operations described above.

Embodiments may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GOSH, or the like) may be transmitted to a semiconductor fabrication facility or “fab” for fabrication.

In addition to the modifications explicitly mentioned above, it will be evident to a person skilled in the art that various other modifications of the described techniques may be made, and that the described techniques have application in other communication systems.

1-30. (canceled)

31. A method comprising: for an initial period after informing a receiving device of a change in the number of carriers configured for transmissions from a transmitting device to the receiving device from a first carrier set to a second carrier set, wherein at least one of the first and second carrier sets contains a plurality of carriers: refraining from scheduling data transmissions to said receiving device on one or more carriers other than those common to both said first and second carrier sets; and decoding feedback information received from said receiving device using a number of code basis sequences according to the number of carriers common to both said first and second carrier sets.

32. A method according to claim 31, comprising: for said initial period, receiving from said receiving device feedback information encoded using a number of code basis sequences according to the number of carriers in the second carrier set; and decoding said feedback information received from said receiving device using a number of code basis sequences according to the number of carriers common to both said first and second carrier sets.

33. A method comprising: transmitting on a control channel from a transmitting device scheduling information for transmissions to or from a receiving device; and including with said scheduling information an indication of a setting for a transmission parameter for feedback information that would otherwise be determined at the receiving device on the basis of a current configuration of the receiving device.

34. A method according to claim 33, wherein said indication is an indication of the number of coding basis sequences to be used for coding feedback information about one or more transmissions received at the receiving device from the transmitting device.

35. A method according to claim 34, wherein said number of coding basis sequences is the number of coding basis sequences to be used for the transmission of feedback information from the receiving device irrespective of the number of carriers for which said receiving device is configured.

36. A method comprising: receiving at a receiving device on a control channel scheduling information for transmissions to or from said receiving device; and checking said scheduling information for an indication of a setting for a transmission parameter for feedback information that would otherwise be determined at the receiving device on the basis of a current configuration of the receiving device.

37. A method according to claim 36, wherein said indication comprises an indication of the number of coding basis sequences to be used for coding feedback information about one or more transmissions received at the receiving device; and comprising coding feedback information for transmission from said receiving device according to said indication.

38. A method according to claim 37, comprising coding feedback information for transmission from said receiving device according to said indication irrespective of the number of carriers for which said receiving device is configured.

39. An apparatus comprising: a processor and memory including computer program code, wherein the memory and computer program code are configured to, with the processor, cause the apparatus to: for an initial period after informing a receiving device of a change in the number of carriers configured for transmissions from a transmitting device to the receiving device from a first carrier set to a second carrier set, wherein at least one of the first and second carrier sets contains a plurality of carriers: refrain from scheduling data transmissions to said receiving device on one or more carriers other than those common to both said first and second carrier sets; and decode feedback information received from said receiving device using a number of code basis sequences according to the number of carriers common to both said first and second carrier sets.

40. An apparatus according to claim 39, wherein the memory and computer program code are configured to, with the processor, cause the apparatus to: for said initial period, receive from said receiving device feedback information encoded using a number of code basis sequences according to the number of carriers in the second carrier set; and decode said feedback information received from said receiving device using a number of code basis sequences according to the number of carriers common to both said first and second carrier sets.

41. An apparatus comprising: a processor and memory including computer program code, wherein the memory and computer program code are configured to, with the processor, cause the apparatus to: transmit on a control channel from a transmitting device scheduling information for transmissions to or from a receiving device; and include with said scheduling information an indication of a setting for a transmission parameter for feedback information that would otherwise be determined at the receiving device on the basis of a current configuration of the receiving device.

42. An apparatus according to claim 41, wherein said indication is an indication of the number of coding basis sequences to be used for coding feedback information about one or more transmissions received at the receiving device from the transmitting device.

43. An apparatus according to claim 42, wherein said number of coding basis sequences is the number of coding basis sequences to be used for the transmission of feedback information from the receiving device irrespective of the number of carriers for which said receiving device is configured.

44. An apparatus comprising: a processor and memory including computer program code, wherein the memory and computer program code are configured to, with the processor, cause the apparatus to: receive at a receiving device on a control channel scheduling information for transmissions to or from said receiving device; and check said scheduling information for an indication of a setting for a transmission parameter for feedback information that would otherwise be determined at the receiving device on the basis of a current configuration of the receiving device.

45. An apparatus according to claim 44, wherein said indication comprises an indication of the number of coding basis sequences to be used for coding feedback information about one or more transmissions received at the receiving device; and wherein the memory and computer program code are configured to, with the processor, cause the apparatus to code feedback information for transmission from said receiving device according to said indication.

46. An apparatus according to claim 45, wherein the memory and computer program code are configured to, with the processor, cause the apparatus to code feedback information for transmission from said receiving device according to said indication irrespective of the number of carriers for which said receiving device is configured.

47. A computer program product comprising program code means which when loaded into a computer controls the computer to: transmit on a control channel from a transmitting device scheduling information for transmissions to or from a receiving device; and include with said scheduling information an indication of a setting for a transmission parameter for feedback information that would otherwise be determined at the receiving device on the basis of a current configuration of the receiving device.

48. A computer program product comprising program code means which when loaded into a computer controls the computer to: receive at a receiving device on a control channel scheduling information for transmissions to or from said receiving device; and check said scheduling information for an indication of a setting for a transmission parameter for feedback information that would otherwise be determined at the receiving device on the basis of a current configuration of the receiving device.
